(19) United States
(12) Patent Application Publication
(10) Pub. No.: US 2009/0278923 A1
(43) Pub. Date: Nov. 12, 2009

(54) DEFECT REVIEW METHOD AND APPARATUS

(75) Inventor: Fumiaki ENDO, Hitachinaka (JP)

Correspondence Address: MILES & STOCKBRIDGE PC, 1751 PINNACLE DRIVE, SUITE 500, MCLEAN, VA, 22102-3833, US

(73) Assignee: HITACHI HIGH-TECHNOLOGIES CORPORATION

(21) Appl. No.: 12/430,070

(22) Filed: Apr. 25, 2009

(30) Foreign Application Priority Data
May 8, 2008 (JP) 2008-122626

(51) Int. Cl. H04N 7/18; G06K 9/00

(52) U.S. Cl. 348/79; 382/149; 348/92; 348/E07.085

(57) ABSTRACT

A defect review apparatus comprises a storage for receiving and storing defect information concerning an inspection objective captured by a wafer inspection system, an image acquisition unit for capturing images concerning the inspection objective and a process unit for acquiring data for defect review based on the defect information by using the image acquisition unit. The process unit makes a decision as to whether a cluster representative of a set or gang of defects exists in the defect information read out of the storage unit and when the presence of the cluster is determined, acquires an image of a defective portion forming part of the cluster and additional data in respect of the inspection objective by using the image acquisition unit on the basis of a distributive feature of the cluster.

### BACKGROUND OF THE INVENTION

The present invention relates to techniques for finding out defects in a semiconductor device (product or parts) during its manufacturing process and for coping with them.

In the manufacturing process of a semiconductor device such as semiconductor wafer, photomask and magnetic disc, foreign matters on the surface of the semiconductor device and pattern defects as well are responsible for causes of a faulty product and search and clarification of failure root causes of faults is important. To this end, it is necessary to quantify the foreign matter and pattern defect (hereinafter referred to as appearance fault) with a view to constantly monitoring the presence or absence of problems in the manufacturing apparatus and environment. In addition, confirmation as to whether or not the appearance fault has a fatal influence upon a product needs to be made by observing the shape or contour of the appearance fault.

The observation work has hitherto been carried out with the help of human eye in many cases. Accordingly, there arises a problem that the position and kind of a defect is biased depending on an observation attendant person or the defect to be observed is not determined definitely. Lately, for the sake of solving the problematic points as above, the introduction of techniques of automatic defect review (ADR) and automatic defect classification (ADC) has been started. For example, a system has been proposed according to which during observation or review (defect review) of an inspected parts (for example, a pattern formed on a wafer) by using an observation unit of scanning electron microscope (SEM) type, the work can proceed while reducing loads imposed on an operator (see U.S. Pat. No. 6,259,960B1, for instance).

Further, in recent years, the critical dimension in working or fabricating semiconductor devices has been minified and the defect has also been minified correspondingly. Therefore, there urgently arise needs for changing conditions of inspection in an inspection unit adapted to draw out defects and for outputting at a time a plurality of defects extracted under individual inspection conditions. On the other hand, as the sensitivity of the inspection unit increases, the output of the inspection unit becomes highly vulnerable to noise and the number of defective points detected per one process of inspection may sometimes exceed several tens of thousand. Then, for elimination of the noise, a method has been known in which defects now under inspection are sorted pursuant to the real-time defect classification (RDC) function and then the noise is eliminated.

Furthermore, in order to determine inspection conditions in the inspection unit and conditions in using the RDC function for noise elimination, a technique has been proposed according to which as many as possible pieces of information delivered out of the inspection unit, information about identification (ID) and coordinates of a defect delivered out of the observation unit and ADR information and ADC information also delivered out of the observation unit as well are readjusted to facilitate the defect analysis (see JP-A-2001-156141, for instance).

### SUMMARY OF THE INVENTION

But, by merely reviewing defects found out by the inspection unit as in the aforementioned related arts, causes of defects cannot be grasped accurately in many cases. Accordingly, the attendant person watches the distribution of defects and if suspicious defects in critical dimension, alignment (register of positions of individual layers) and film thickness are questioned, the measured pieces of data are confirmed to search causes of the defects. The attendant person, however, is not always near the apparatus and when the attendant person is unattended, for example, at night, the semiconductor device (such as wafer) is permitted to proceed to the next process and decisive evidences cannot often be acquired on the spot, leading to a delay in taking countermeasures against the defect. Even when confirmation after the fact is desired to be made, the measurement as above is not conducted for all wafers and all dies but is conducted only for sampled wafers and dies and accordingly, the defective portion in want of knowledge cannot be known directly but can merely be estimated from temporally and spatially close data in many cases.

Under the circumstances, the present invention contemplates the elimination of the conventional problems as above and its object is to provide defect review method and apparatus which can acquire information profitable to post-review when a defect is found in, for example, the semiconductor device in the course of manufacture.

To accomplish the above object, a defect review method according to this invention is based on a defect review apparatus having a storage for receiving and storing defect information concerning an inspection objective captured by a wafer inspection system, an image acquisition unit for capturing images concerning the inspection objective and a process unit for acquiring data for defect review based on the defect information by using the image acquisition unit.

The process unit makes a decision as to whether a cluster representative of a set or gang of defects exists in the defect information read out of the storage, and when the presence of the cluster is determined, acquires an image of a defective portion forming part of the cluster and additional data in respect of the inspection objective by using the image acquisition unit on the basis of a distributive feature of the cluster.

Other expedients will be described later.

According to the present invention, when a defect in the semiconductor device or the like is found out in the manufacturing process, information profitable for post-review can be obtained.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing the overall construction of a defect review arrangement according to an embodiment of the invention.

FIG. 2 is a functional block diagram showing part of the overall construction in the embodiment.

FIG. 3 is a diagram showing an example of defect information.

FIG. 4 is a flowchart of a first process example.

FIGS. 5A to 5C are diagrams showing an example of a wafer map when dependency prevails within the wafer surface.

FIGS. 6A to 6D are diagrams showing another example of the wafer map when dependency prevails within the wafer surface.

FIGS. 7A and 7B are diagrams showing an example of the wafer map when dependency prevails within a die.

FIG. 8 is a diagram showing an example of the wafer map when dependency is not prevailing either within the wafer surface or within the die.

FIGS. 9A and 9B depict a flowchart showing a second process example.

FIGS. 10A to 10C are diagrams showing still another example of the wafer map when the dependency prevails within the wafer surface.

### DESCRIPTION OF THE INVENTION

Preferred embodiments of the present invention will now be described with reference to the accompanying drawings. In the present embodiment, a review apparatus (defect review apparatus) of the present invention will be described as being applied to the production line of semiconductor devices and a defect review method will be described as being practiced on the semiconductor device production line.

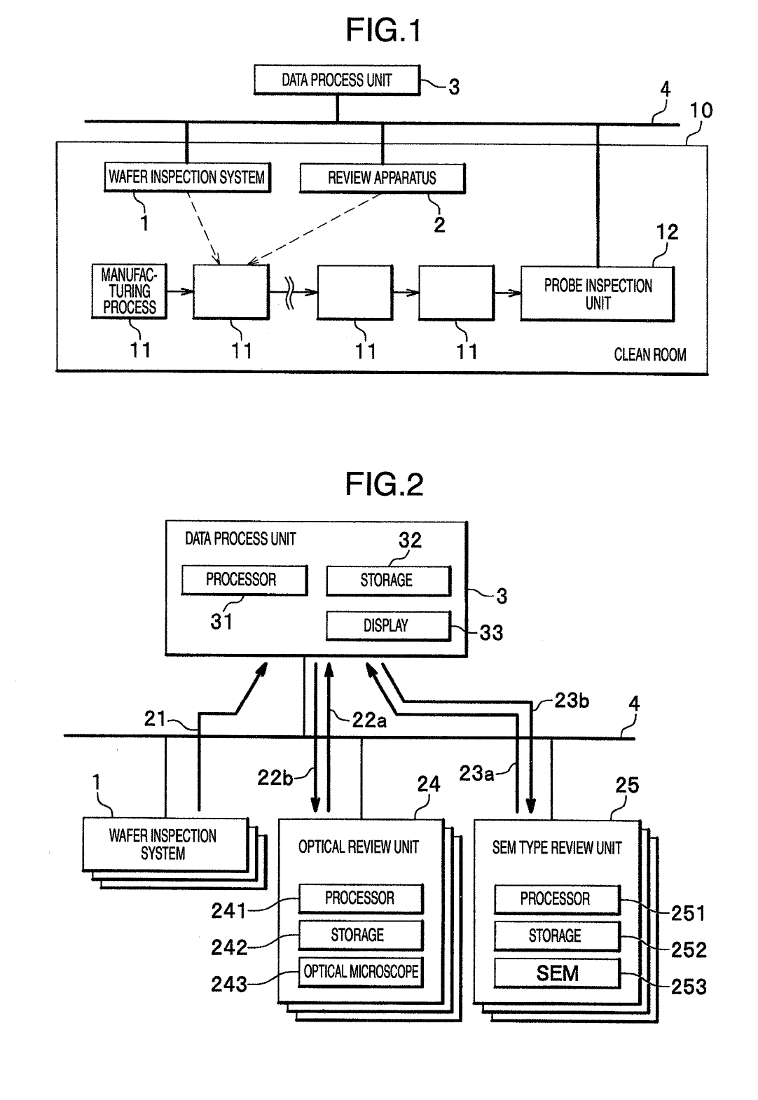

Referring first to FIG. 1, the overall construction of a defect review arrangement according the present embodiment is illustrated. As will be seen from FIG. 1, a plurality of manufacturing processes 11 for a semiconductor device are practiced with individual manufacturing units located internally of a clean room 10 in which a clean environment is maintained typically. Installed inside the clean room 10 are a wafer inspection system 1 for inspecting appearance faults of product wafers (semiconductor devices) and a review apparatus 2 for observing or reviewing appearance faults on the basis of data from the wafer inspection system 1.

The wafer inspection system 1 can be materialized with, for example, a brightfield wafer inspection tool, a darkfield wafer inspection tool, an SEM type wafer inspection tool or a charge coupled device (CCD) camera. Details of the review apparatus 2 will be described later. The wafer inspection system 1 and review apparatus 2 are illustrated by dashed line in FIG. 1 as being in charge of the same single manufacturing process 11 but this is not limitative and they can handle plural or different manufacturing processes 11.

The wafer inspection system 1 and review apparatus 2 are connected through a communication line 4 to a data process unit 3 representing a destination to which inspection data and image data are transmitted. Wafers for a product flow in a unit of lot along the manufacturing processes 11. A wafer having gone through all of the manufacturing processes 11 undergoes a probe test in a probe inspection unit 12. After having been processed through the manufacturing processes 11 in connection with which the execution of the appearance inspection is prescribed in advance, the wafer is conveyed to a place where the wafer inspection system 1 is located by a work person or by means of a conveyer.

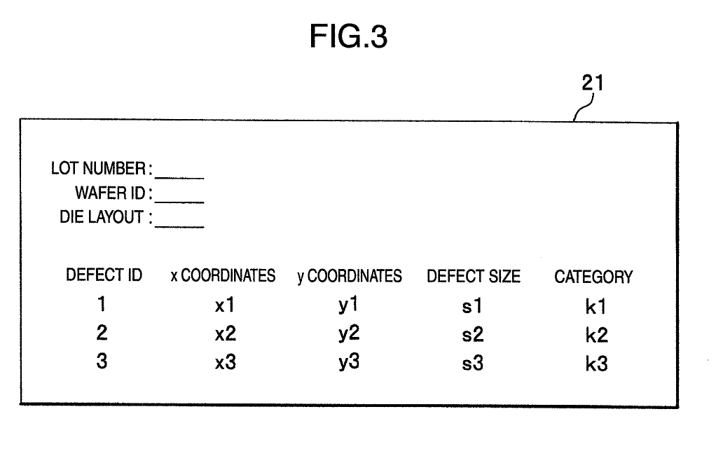

Turning to FIG. 2, part of the overall construction in the present embodiment is illustrated. As shown in FIG. 2, the review apparatus 2 in FIG. 1 is comprised of, for example, an optical review unit 24 and an SEM type review unit 25. The optical review unit 24 includes a processor 241 constructed of a central processing unit (CPU) and random access memories (RAM's) and adapted to execute various kinds of operation processes, a storage 242 constructed of read only memories (ROM's) and a hard disk drive (HDD) and adapted to store various kinds of information and programs, an optical microscope 243 (image acquisition unit), an input interface (not shown) and a communication interface (not shown). The SEM type review unit 25 includes a processor 251 constructed of a CPU and RAM's and adapted to execute various kinds of operations, a storage 252 constructed of ROM's and a HDD and adapted to store various kinds of information and programs, an SEM 253 (image acquisition unit), an input interface (not shown) and a communication interface (not shown). The data process unit 3 includes a processor 31 constructed of a CPU and RAM's and adapted to execute various kinds of operations, a storage 32 constructed of ROM's and a HDD and adapted to store various kinds of information and programs, a display 33 constructed of a liquid crystal display device, for example, and adapted to perform various kinds of display, an input interface (not shown) and a communication interface (not shown).

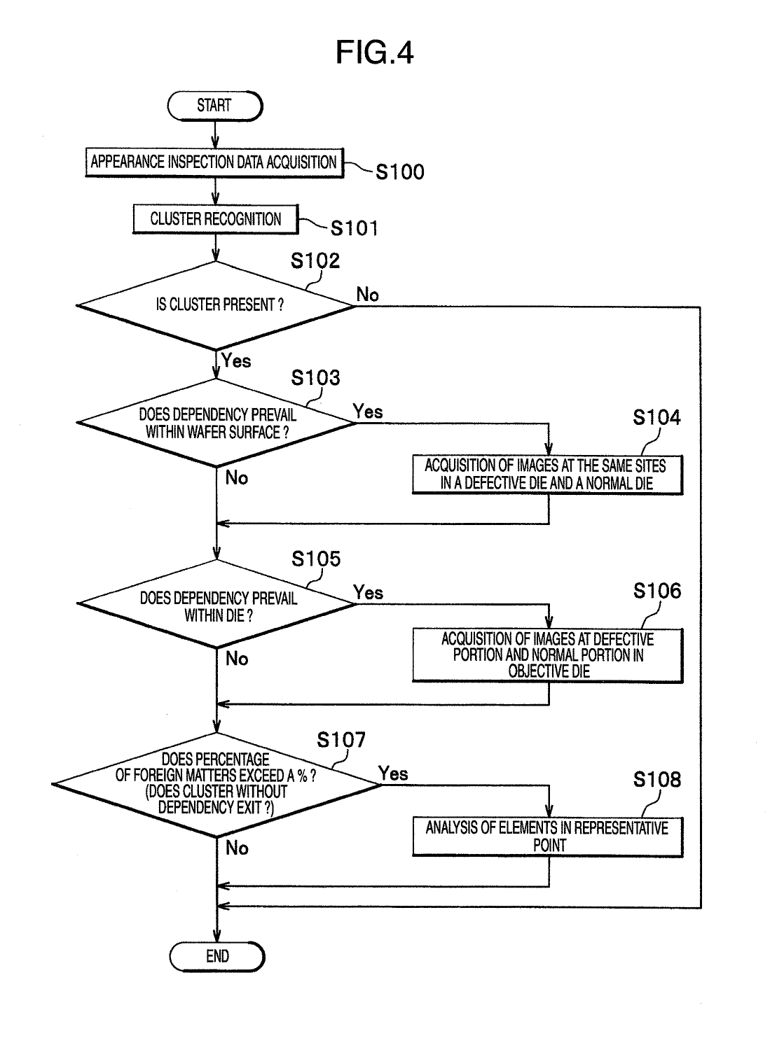

Defect information 21 (appearance data) obtained through the appearance inspection by the wafer inspection system 1 is transmitted to the data process unit 3 and is stored, together with a lot number, a wafer ID, an inspection process and an inspection date, in the storage 32 of data process unit 3. An example of the defect information 21 is illustrated in FIG. 3. As shown in FIG. 3, the defect information 21 is itemized by lot number, wafer ID and die layout of a wafer and by ID, coordinates (x coordinates and y coordinates), size and category of a defect detected during inspection. In addition, the defect information 21 may include as necessary the inspection data, inspection process, defect ADR image, defect feature factor information (RDC information) and the like.

Reverting to FIG. 2, the wafers having experienced the appearance inspection by means of the wafer inspection system 1 are conveyed to the review apparatus 2 by the work person or by means of the conveyor so as to be observed and checked for an appearance inspection fault, whereby a predetermined wafer is taken out of a lot and reviewed. In reviewing, defect information 21 is acquired from the storage 32 of data process unit 3 by using, as key information, such information of the wafer to be reviewed as lot number, wafer ID and inspection process. It is assumed that the defect information 21 includes not only the defect ID and coordinate data but also the ADR image obtained during inspection.

Since pieces of the defect information 21 delivered out of the wafer inspection system 1 are enormous, defect information 22b or 23b drawn out by the data process unit 3 through a plurality of filter functions is sent to the optical review unit 24 or SEM type review unit 25 via the communication line 4. The format of defect information 22b or 23b may be the same as or different from that of defect information 21.

On the basis of the extracted defect information 22b or 23b, an image of the defect portion is captured in the optical review unit 24 or SEM type review unit 25 and by using the image, defect classification is carried out with ADC function loaded in each tool constituting the review apparatus 2. The thus obtained information is transmitted as ADR/ADC information 22a or 23a to the data process unit 3 by way of the communication line 4 and stored in the storage 32. The ADR/ADC information 22a or 23a is obtained when the defect in the semiconductor device is found out in the manufacturing process 11. This information is useful for post-review and the user can watch it on the display 33. The process for obtaining the information useful for review will be explained below by using first and second process examples.

### FIRST PROCESS EXAMPLE

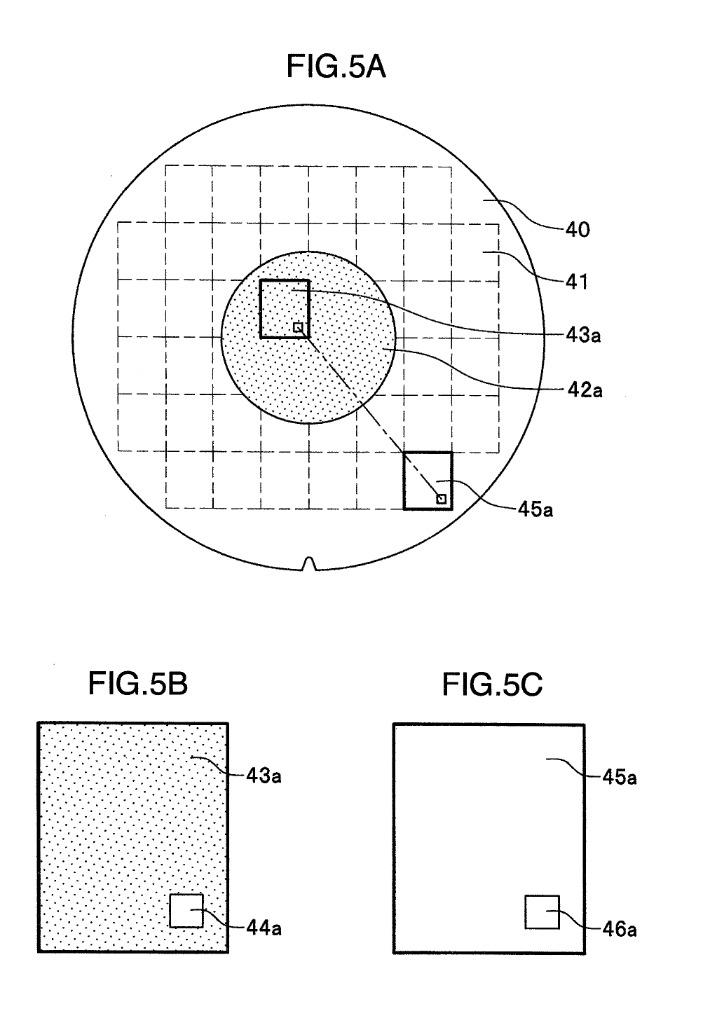

By making reference to FIG. 4 to FIG. 8, a first process example will be explained. A flowchart showing the first process example is depicted in FIG. 4. The processor 241 of optical review unit 24 or the processor 251 of SEM type review unit 25 operates dominantly in the process and is generally described as the review apparatus 2.

Firstly, in step S100, the review apparatus 2 captures appearance inspection data from the data process unit 3.

Next, in step S101, the review apparatus 2 conducts a process of cluster recognition on the basis of defect information 21 in the appearance inspection data. The cluster recognition process can be practiced through a method shown in, for example, the JP-A-2005-197629. The cluster referred to herein signifies that a plurality of defects form a set or gang in a specified relationship and it means a gang of the defects (also termed a cluster defect).

In step 102, the review apparatus 2 makes a decision as to whether a cluster exists. If the absence of any cluster is determined (No in step S102), the review apparatus ends the process.

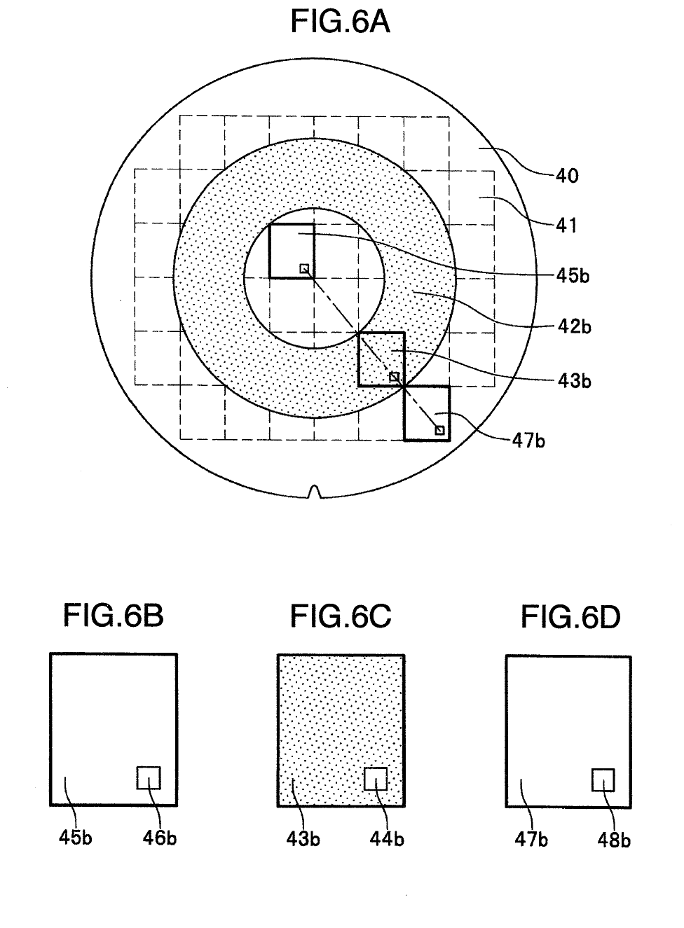

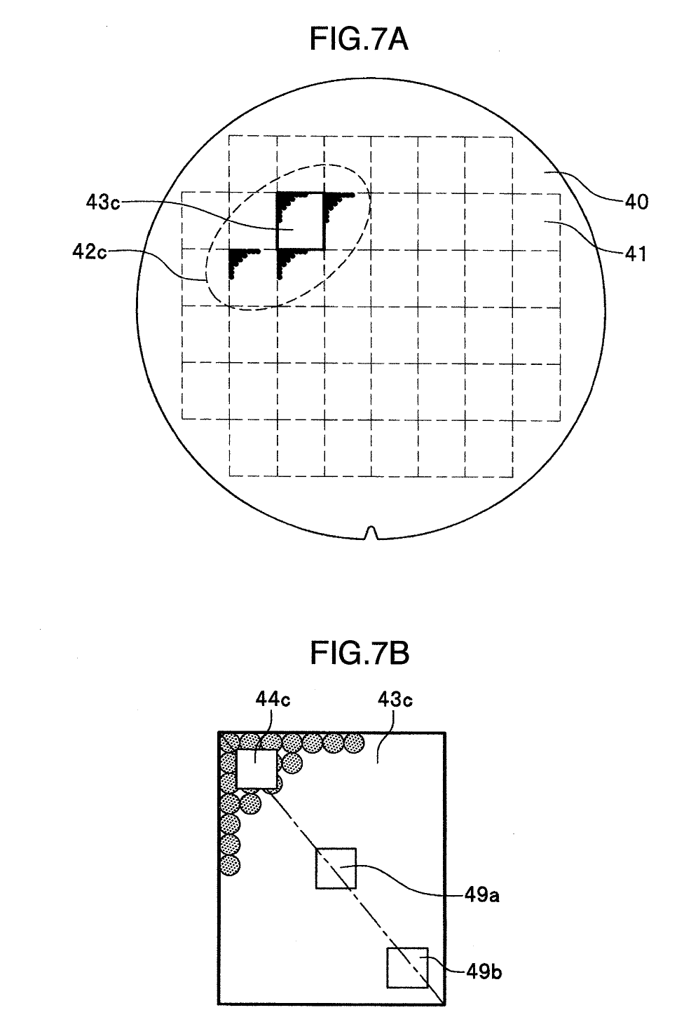

If the presence of clusters is determined (Yes in step S102), the review apparatus 2 makes a decision as to whether dependency (pattern-wise or trend-wise) prevails in respect of the individual clusters within the wafer surface in step S103 as will be detailed later with reference to FIGS. 5 and 6.

If the presence of the dependency prevailing within the wafer surface is determined (Yes in step S103), the review apparatus 2 captures images at the same sites in a defective die and a normal die (mutually corresponding sites), respectively, in step S104 as will be detailed later with reference to FIGS. 5 and 6.

Following No in the step 103 or following the step S104, the review apparatus 2 decides whether dependency prevails within a die in respect of the individual clusters in step S105 as will be detailed later with reference to FIG. 5.

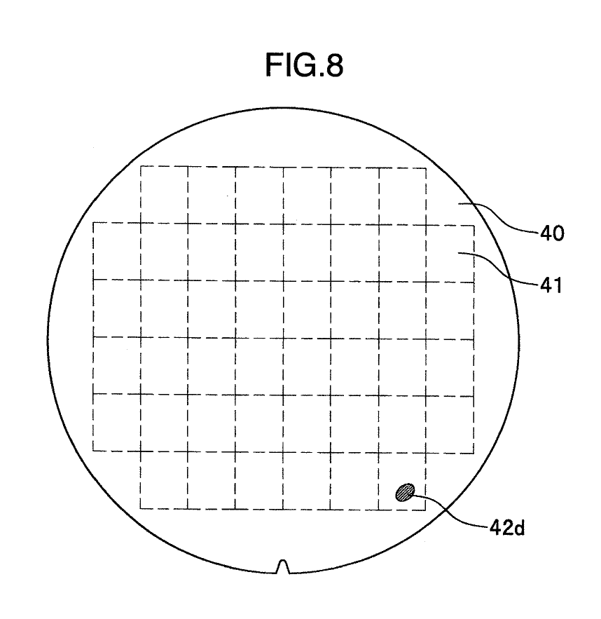

If the presence of the dependency within the die is determined (Yes in step S105), the review apparatus 2 captures images at a defective site (defective portion) and a normal site, respectively, in the objective die in step S106 as will be detailed later with reference to FIG. 7.

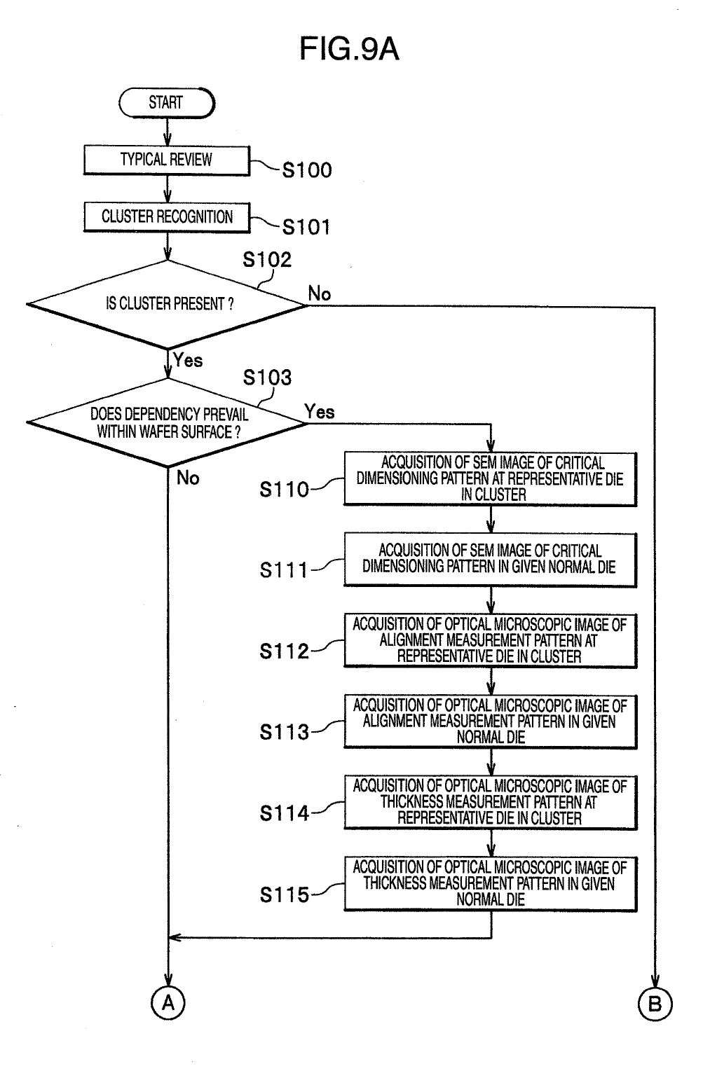

Following No in the step S105 or following the step S106, the review apparatus 2 decides whether the percentage of foreign matters (the ratio between the numbers of dies in which foreign matters exist) exceeds A % (predetermined value) in respect of the wafer having individual clusters (in case the review apparatus 2 lacks the ADC function, a decision is made as to whether a cluster having no dependency either within wafer surface or within die exists) in step S107 as will be detailed later with reference to FIG. 8.

If Yes in the step S107, the review apparatus 2 analyzes elements at a representative point and obtains a result of analysis of elements in the defective portion (additional data) in step S108 as will be detailed later with reference to FIG. 8. The element analysis is executed for the purpose of examining component elements of foreign matter on the assumption that the main cause of the defect is the foreign matter and it can be executed with the help of, for example, an energy-dispersive X-ray spectroscopy (EDS) analyzer attached to the SEM type review unit 25.

Following No in the step S107 or following the step S108, the review apparatus 2 ends the process.

Referring now to FIGS. 5A to 5C, an example of a wafer map when the dependency prevails within the wafer surface is illustrated. Exemplarily, FIG. 5A shows the overall wafer, FIG. 5B shows a defective die and FIG. 5C shows a normal die. As shown in FIG. 5A, many dies 41 are present on a wafer 40 and a cluster defect 42a exists over dies. In this example, defects are concentrated in a central circular area on the wafer 40. In this case, when it is decided in the step S103 (see FIG. 4) that the dependency prevails within the wafer surface, an image 44a (see FIG. 5B) of a representative defect is captured from the cluster in the step S104 (see FIG. 4) and an image 46a at the same site within a normal die 45a as that of the defective image 44a, the normal die being outside the cluster at the remotest site from a die 43a inclusive of defects and assumed to be normal on account of its position distant from the die 43a, is captured as (additional data) in the step S104 (see FIG. 4).

In FIG. 5A, the circular cluster is exemplified but a linear or circular arc cluster can be processed in a similar manner. In FIGS. 6A to 6D, another example of the wafer map when the dependency prevails within the wafer surface is illustrated. Exemplarily, FIG. 6A shows the overall wafer, FIG. 6B shows a normal die, FIG. 6C shows a defective die and FIG. 6D shows another normal die.

As shown in FIG. 6A, many dies 41 are present on a wafer 40 and a cluster defect 42b exists over dies. In this example, defects are concentrated annularly. In this case, when it is decided in the step S103 (see FIG. 4) that the dependency prevails within the wafer surface, an image 44b (see FIG. 6C) of a representative defect is captured from the cluster in the step S104 (see FIG. 4), an image 46b at the same site within a normal die 45b as that of the defective image 44b, the normal die 45b being the closest to the center of the wafer 40 on a straight line extending from the die 43b inclusive of the defects to the center of the wafer 40, is captured as (additional data) and an image 48b at the same site within a normal die 47b as that of the defective image 44b, the normal die 47b being the remotest on a straight line extending from the center of the wafer toward the defective image 44b, is acquired as (additional data) in the step S104 (see FIG. 4).

Referring now to FIGS. 7A and 7B, another example of the wafer map when the dependency prevails within the wafer surface is illustrated. Exemplarily, FIG. 7A shows the overall wafer and FIG. 7B shows a die. As shown in FIG. 7A, many dies 41 are present on a wafer 40 and a defect area 42c exists. In this example, defects are concentrated in a left upper portion on the sheet of drawing. In the case of such a distribution, it is determined in the step S105 that the dependency prevails within the die, an image 44c (see FIG. 7B) of a representative defect is captured from a cluster and then, images of normal portions (additional data) are captured at an area 49a nearby the center of a die 43c and an area 49b opposite to the defective image 44c with respect to the die center, that is, these areas being point symmetrical to the die center. The number of normal sites where images are captured may be 3 or more.

Turning now to FIG. 8, an example of the wafer map when the dependency does not prevail either within the wafer surface or within the die is illustrated. As shown in FIG. 8, many dies 41 are present on a wafer 40 and a cluster defect 42d exists in a die. In this example, the cluster defect 42d has no dependency either within the wafer surface or within the die (namely, No is determined in the steps S103 and S105 in FIG. 4). In this case, if Yes is issued in the step S107, an element analysis is conducted as described previously at representative points (several points) in the cluster defect 42d in the step S108 to obtain a result of analysis of elements in the defective portion.

As described above, according to the first process example in the present embodiment, when a defect is found out in the semiconductor device in the course of its manufacturing process, an image of the defective portion and an image of a normal portion corresponding thereto can be obtained as information profitable for post-review. This can improve the possibility that the user can know the cause of the defect.

### SECOND PROCESS EXAMPLE

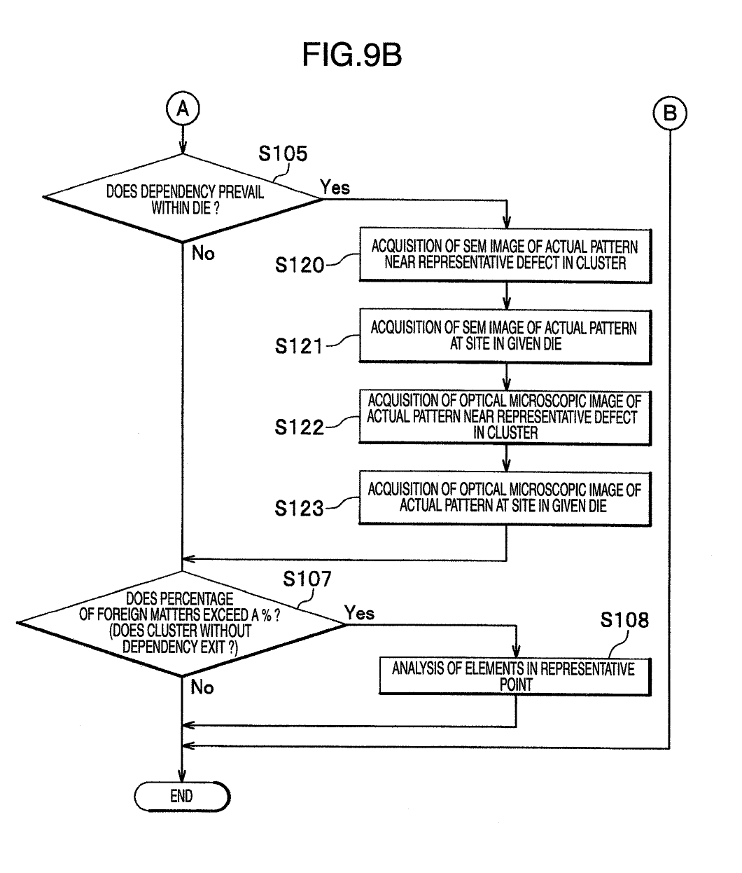

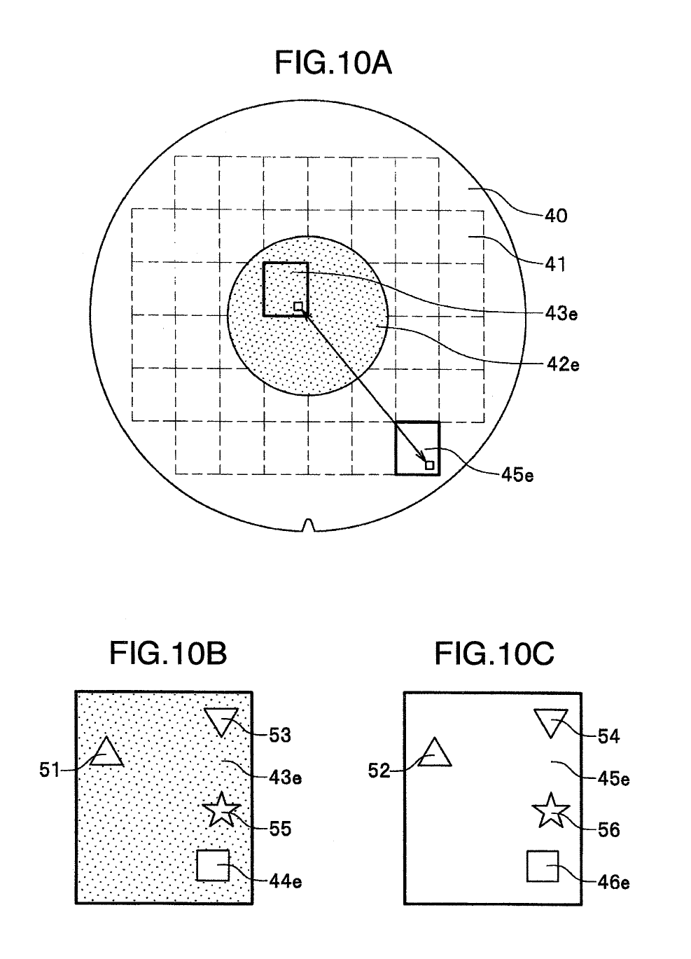

Next, a second process example will be described by making reference to FIGS. 9A and 9B and FIGS. 10A to 10C. FIGS. 9A and 9B depict a flowchart showing the second process example. FIGS. 10A to 10C depict an example of the wafer map when the dependency prevails within the wafer surface, with FIG. 10A showing the whole of a wafer 40 having dies 41 thereon, FIG. 10B showing a defective die and FIG. 10C showing a normal die.

Steps S100 to S103, S105, S107 and S108 in FIGS. 9A and 9B are the same as those in the case of the first process example and will not be described herein.

If Yes is determined in the step S103, the SEM type review unit 25 acquires in step S110 an SEM image of a critical dimensioning pattern 51 (see FIG. 10B) in a defective die 43e (representative die in a cluster 42e) and acquires in step S111 an SEM image (additional data) of a critical dimensioning pattern 52 (see FIG. 10C) in a given normal die 45e. Designated by reference numeral 44e in FIG. 10B is a defective image in the defective die 43e and by reference numeral 46e in FIG. 10C is a normal image corresponding to the defective image 44e in the given normal die 45e.

Subsequently, the optical review unit 24 acquires in step S112 an optical microscopic image of an alignment measurement pattern 53 (see FIG. 10B) in the defective die (representative die in cluster), acquires in step S113 an optical microscopic image (additional data) of an alignment measurement pattern 54 (see FIG. 10C) in the given normal die, acquires in step S114 an optical microscopic image of a thickness measurement pattern 55 (see FIG. 10B) in the defective die (representative die in cluster) and acquires in step S115 an optical microscopic image(additional data) of a thickness measurement pattern 56 (see FIG. 10C) in the given normal die. Generally, the SEM image is considered as being effective for the critical dimensioning and the optical microscopic image is considered as being effective for alignment and thickness measurement and therefore, acquisition of these images is desirable but this is not always limitative.

If Yes is issued in the step S105, the SEM type review unit 25 acquires in step S120 an SEM image of an actual pattern (uncontaminated part of pattern for reference use) nearby the representative defect in cluster and in step S121, captures an SEM image (additional data) of the actual pattern at a site in a given die.

Thereafter, in step S122, the optical review unit 24 captures an optical microscopic image of the actual pattern near the representative defect in cluster and in step S123, captures an optical microscopic image (additional data) of the actual pattern at a site in the given die.

Since, in the steps S120 to S123, the images are captured in the same die, the individual patterns for measurement of, for example, critical dimension are not prepared position by position and the actual pattern is used. In case the objective is a memory product, relatively similar patterns can be found with ease but in other cases, even images of patterns which are not always identical to one another are captured and compared. In that case, it is not necessary to separate images for alignment measurement and thickness measurement and a microscopic image of an actual pattern of each kind is captured.

In the steps S110 and S111, the steps S112 and S113 and the steps S114 and S115, not only images are captured but also measurements may be practiced by having the functions of critical dimensioning measurement, alignment measurement and thickness measurement.

In this manner, according to the second process example in the present embodiment, images for permitting comparison in critical dimension, alignment and thickness between a defective portion and a normal portion corresponding thereto can be acquired and therefore, it is possible to improve the possibility that the user can know the principal cause of a defect or the cause of accelerating degradation of the defect with high speed and high accuracy. By increasing the number of individual images to be captured, a wide range can be watched and the probability of recognizing abnormality (defect) can be raised but the number can be set arbitrarily. In case the number of individual images to be captured is increased, predetermined and specified data which is to be set in the category in the defect information 21 shown in FIG. 3 may be used for the added review point to discriminate it from the ordinary view point.

As set forth so far, with the review apparatus 2 according to the present embodiment, images directly related to the estimation of the cause of a fault can be obtained automatically and hence, the cause of a defect can be searched and clarified more fast and accurately in the present invention than in the case where the person first examines the review result data and again observes the defective portion. Further, in the conventional method in which data of images at the same sites in a defective die and in an adjacent die are acquired, respectively, the difference between the images is relatively small and cannot sometimes become aware of but by capturing images at sites distant from each other (one site being outside of a cluster is the minimum condition. Preferably, the one site is as remote as possible from the cluster) as in the review apparatus 2 of the present embodiment, the difference can be grasped clearly.

In closing giving the description of the present embodiment, it should be understood that the present invention is in no way limited to the embodiment and examples set forth so far. For example, the semiconductor device representing the inspection objective is not limited to the wafer but the present invention may be applied to another inspection objective having a pattern such as a matrix arrangement. Further, the present invention can be modified and altered in specified structure and construction without departing from the gist of the present invention.

It should be further understood by those skilled in the art that although the foregoing description has been made on embodiments of the invention, the invention is not limited thereto and various changes and modifications may be made without departing from the spirit of the invention and the scope of the appended claims.

1. A defect review method based on a defect review apparatus having a storage for receiving and storing defect information concerning an inspection objective captured by a wafer inspection system, an image acquisition unit for capturing images concerning the inspection objective and a process unit for acquiring data for defect review based on the defect information by using the image acquisition unit,
wherein said process unit makes a decision as to whether a cluster representative of a set or gang of defects exists in the defect information read out of said storage, and when the presence of the cluster is determined, acquires an image of a defective portion forming part of said cluster and additional data in respect of said inspection objective by using said image acquisition unit on the basis of a distributive feature of said cluster.

2. A defect review method according to claim 1, wherein said additional data is an image at a site assumed to be a normal portion which is positioned distantly from said defective portion in said inspection objective.

3. A defect review method according to claim 1, wherein said additional data is a result of analysis of elements in said defective portion in said inspection objective.

4. A defect review method according to claim 1, wherein said additional data is a result of critical dimensioning of said defective portion in said inspection objective.

5. A defect review method according to claim 1, wherein said additional data is a result of alignment measurement of plural layers constituting said defective portion in said inspection objective.

6. A defect review method according to claim 1, wherein said wafer inspection system is any one of brightfield wafer inspection tool, darkfield wafer inspection tool and scanning electron microscope (SEM) type inspection unit, and said image acquisition unit is either one or both of an optical microscope and an SEM.

7. A defect review apparatus comprising:
a storage for receiving and storing defect information concerning an inspection objective captured by a wafer inspection system;
an image acquisition unit for capturing images concerning the inspection objective; and
a process unit for acquiring data for defect review based on the defect information by using said image acquisition unit,
wherein said process unit makes a decision as to whether a cluster representative of a set or gang of defects exists in the defect information read out of said storage, and when the presence of the cluster is determined, acquires an image of a defective portion forming part of said cluster and additional data in respect of said inspection objective by using said image acquisition unit on the basis of a distributive feature of said cluster.

8. A defect review apparatus according to claim 7, wherein said additional data is an image at a site assumed to be a normal portion which is positioned distantly from said defective portion in said inspection objective.

9. A defect review apparatus according to claim 7, wherein said additional data is a result of analysis of elements in said defective portion in said inspection objective.

10. A defect review apparatus according to claim 7, wherein said additional data is a result of critical dimensioning of said defective portion in said inspection objective.

11. A defect review apparatus according to claim 7, wherein said additional data is a result of alignment measurement of plural layers constituting said defective portion in said inspection objective.

12. A defect review apparatus according to claim 7, wherein said wafer inspection system is any one of brightfield wafer inspection tool, darkfield wafer inspection tool and scanning electron microscope (SEM) type inspection unit, and said image acquisition unit is either one or both of an optical microscope and an SEM.
